(19) United States
(12) Patent Application Publication
(10) Pub. No.: US 2024/0154369 A1
(43) Pub. Date: May 9, 2024

(54) SURGE PROTECTOR CONFIGURED TO PROTECT ETHERNET EQUIPMENT FROM SURGES VIA A WALL OUTLET

(71) Applicant: PPC BROADBAND, INC., East Syracuse, NY (US)

(72) Inventors: Brian HANSON, Cicero, NY (US); Noah MONTENA, Syracuse, NY (US)

(73) Assignee: PPC BROADBAND, INC., East Syracuse, NY (US)

(21) Appl. No.: 18/387,312

(22) Filed: Nov. 6, 2023

Related U.S. Application Data
(60) Provisional application No. 63/423,040, filed on Nov. 6, 2022.

(51) Int. Cl. H01R 13/66; H01R 12/72; H01R 24/64; H02H 9/02; H02H 9/04

(52) U.S. Cl. CPC H01R 13/6666; H01R 12/722; H01R 24/64; H02H 9/02; H02H 9/044

(57) ABSTRACT

A surge protector is configured to protect Ethernet equipment from an electrical surge. The surge protector includes an Ethernet cable input portion structurally configured to receive an Ethernet input cable, an Ethernet cable output portion structurally configured to receive an Ethernet output cable to connect to an Ethernet device, a ground plug portion having a dummy portion and a ground portion, and wherein the ground portion is structurally configured to connect to an electrical wall outlet so as to direct an electrical surge on the input Ethernet cable to a ground of the electrical wall outlet so as to protect equipment that is electrically connected with the output Ethernet cable from the electrical surge.

### CROSS REFERENCE TO RELATED APPLICATION

This application claims priority from U.S. Provisional Application No. 63/423,040 filed Nov. 6, 2022, the disclosure of which is hereby incorporated by reference herein in its entirety.

### TECHNICAL FIELD

The present disclosure generally relates to the field of surge protectors, and more particularly to the field of Ethernet surge protectors.

### BACKGROUND

Surge protection is the process of protecting electronic systems or equipment from voltages and currents which are outside their safe operating limits. Surge voltages and surge currents can be generated by short circuits, lightning or faults from a power system, and they may enter the electronic system along inter-equipment wiring. As in the case of a lightning strike, for example, the surges may be galvanically coupled into an electronic system through an inadvertent connection of the power system to wiring. In another example, the surges may be capacitively coupled into an electronic system that is in the vicinity of a high voltage power line. In another example, the surges may be inductively coupled into the electronic system if electronic wiring is run in parallel with a power circuit.

Surge protection devices may be used for protecting electronic systems or equipment from surges. Specifically, an Ethernet surge protection device may protect Ethernet interface devices that are used in a computer system and/or a server system. Conventional Ethernet surge protection devices are not mounted to a wall of a building because they lack mounting components for fitting into a standard bulkhead panel. As such, conventional Ethernet surge protection devices are installed adjacent to the Ethernet interface devices, which are generally located inside a building.

Existing Ethernet surge protection devices may require professional installation given that the surge protection device must be attached to a proper earth ground. Under this circumstance, up to 25 feet of copper wire may need to be run from the surge protector to a ground point. Additional equipment may be required to attach the copper wire to the ground point. Accordingly, there is a need to allow easy installation of a surge protection device without having to connect the surge protection device to a copper wire and connecting that copper wire to a proper earth ground.

### SUMMARY

A surge protector is configured to protect Ethernet equipment from an electrical surge. The surge protector includes a housing portion configured to have a first housing portion and a second housing portion, a printed circuit board structurally configured to be disposed within the housing portion and configured to be electrically coupled with an input Ethernet cable and with an output Ethernet cable, and a ground plug portion structurally configured to include a panel portion, a dummy portion, and a ground portion, wherein the second housing portion is structurally configured to include an electrical coupling portion, wherein the ground portion is structurally configured to includes a proximate end extending beyond a first side of the panel portion and a distal end extending beyond the a second side of the panel portion, wherein the ground portion is structurally configured to extend from the second side of the panel portion, wherein the proximate end of the ground portion is structurally configured to be electrically coupled with the printed circuit board via the electrical coupling portion, and the distal end of the ground portion is structurally configured to be electrically coupled with a ground of an electrical wall outlet, wherein the second housing portion is configured to define a port on a rear exterior side of the housing portion such that the port is structurally configured to receive the panel portion of the ground plug portion, wherein the electrical coupling portion of the second housing portion includes a first end structurally configured to extend beyond an interior side of the second housing portion and a second end, wherein the second end of the electrical coupling portion is a ring such that at least a portion of the ring is structurally configured to extend beyond the rear exterior side of the second housing portion, wherein the ground plug portion is structurally configured to mechanically couple the housing portion to an electrical wall outlet, and wherein the ground portion and the electrical coupling portion of the housing portion are structurally configured to electrically couple the printed circuit board to a ground of an electrical wall outlet via the ground plug portion when the housing portion is coupled to the electrical wall outlet such that an electrical surge on the input Ethernet cable is directed to the ground of the electrical wall outlet so as to protect equipment that is electrically connected with the output Ethernet cable from the electrical surge.

A surge protector is configured to protect Ethernet equipment from an electrical surge. The surge protector includes an Ethernet cable input portion structurally configured to receive an Ethernet input cable, an Ethernet cable output portion structurally configured to receive an Ethernet output cable to connect to an Ethernet device, a ground plug portion having a dummy portion and a ground portion, a printed circuit board structurally configured to be electrically coupled to the ground portion, to the Ethernet cable input portion, and to the Ethernet cable output portion, and wherein the ground portion is structurally configured to connect with an electrical wall outlet so as to direct an electrical surge on the input Ethernet cable to a ground of the electrical wall outlet via the printed circuit board so as to protect equipment that is electrically connected with the output Ethernet cable from the electrical surge.

A surge protector is configured to protect Ethernet equipment from an electrical surge. The surge protector includes an Ethernet cable input portion structurally configured to receive an Ethernet input cable, an Ethernet cable output portion structurally configured to receive an Ethernet output cable to connect to an Ethernet device, a ground plug portion having a dummy portion and a ground portion, and wherein the ground portion is structurally configured to connect to an electrical wall outlet so as to direct an electrical surge on the input Ethernet cable to a ground of the electrical wall outlet so as to protect equipment that is electrically connected with the output Ethernet cable from the electrical surge.

### BRIEF DESCRIPTION OF THE DRAWINGS

Further advantages and features of the present disclosure will become apparent from the following description and the accompanying drawings, to which reference is made. In which are shown:

FIG. 1 is a schematic view of ground potential rise (GPR).

FIG. 2 is a schematic circuit diagram of an example of a common node surge wherein a surge protection circuit is implemented.

FIG. 3 is an isometric upper front view of an exemplary surge protection device according to various aspects of the present disclosure.

FIG. 4 is an isometric rear view of the surge protection device of FIG. 3 where the grounding plug is mounted within the port.

FIG. 5A is a first isometric view of an exemplary ground plug.

FIG. 5B is a second isometric view of the exemplary ground plug.

FIG. 6A is an isometric upper front view of the second housing member before the printed circuit board is installed.

FIG. 6B is an isometric upper front view of the second housing member after the printed circuit board is installed.

FIG. 7 is an isometric rear view of the surge protection device of FIG. 3 before the grounding plug is mounted within the port.

FIG. 8 is a side schematic view of the exemplary surge protection device mounted on the wall wherein the grounding plug electrically and mechanically couples the surge protection device to a three-prong outlet on the wall.

FIG. 9 is a front view of the electrical coupling member of the second housing member.

FIG. 10 is a cross-sectional view of the surge protection device of FIG. 3.

FIG. 11 is an exploded view of the surge protection device of FIG. 3.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The subject of damage to Ethernet ports due to surges in current has received increased attention in recent years. For reasons that are not fully understood, more manufacturers are experiencing field failures caused by visible surge damage to Ethernet ports. Other suspected surge failures do not show visible damage, but the timing of the failures correlates with local thunderstorm activity.

The IEEE 802.3 standard defines a method for delivering DC power over an Ethernet cable. Current versions of power over ethernet (PoE) use two of the four pairs in the cable to deliver DC current to the far end. One pair serves as the source, while the other pair serves as the return. The standard defines two choices for delivering the DC power. Mode A uses pairs 1 and 2, while Mode B uses pairs 3 and 4.

The DC voltage is typically in the range of 50 volts, with the current limited to approximately 270 mA. This provides the ability to deliver up to 13 watts of power to a device connected to the far end of the Ethernet cable. For remote devices such as telephones and security cameras, the main benefit of PoE is that it eliminates the need for a separate power supply to power the remote device.

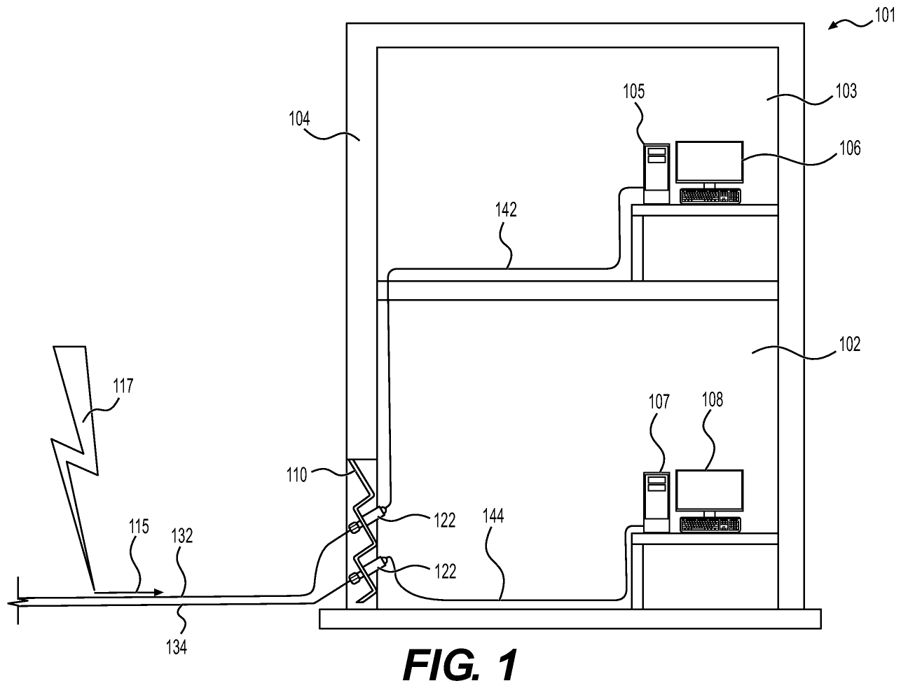

FIG. 1 shows a mechanism called ground potential rise (GPR). GPR is often the root cause of surge failures on communication cables. When lightning strikes the ground, currents up to 100 kA flow through the soil toward the center of the earth. However, since the soil has a finite resistance, the lightning current 117 spreads out in many directions. However, the lighting 117 causes an electric surge 117 that may also travel along the cables such that GPR can cause surge damage to Ethernet ports.

FIG. 1 also shows a building 101 with a traditional internally mounted Ethernet surge protection (ESP) device 122. The building 101 may be a commercial and/or residential building having one or more floors, such as a first floor 102 and a second floor 103. The second floor 103 may be equipped with a first Ethernet enabled computer 105, which may be used in conjunction with a first monitor 106. The first floor 102 may be equipped with a second Ethernet enabled computer 107, which may be used in conjunction with a second monitor 108.

The first and second Ethernet enabled computers 105 and 107 may be connected to one or more computer networks via one or more Ethernet cables. For example, the first Ethernet enabled computer 105 may be connected to a first protected Ethernet cable 142, the internally mounted ESP device 122, and a first unprotected Ethernet cable 132.

The first and second unprotected Ethernet cables 132 and 134 may be disposed outside the building 101. The first and second unprotected Ethernet cables 132 and 134 may each conduct an Ethernet signal. The voltage and current of the Ethernet signal may be affected by several external conditions, such as lightning, power line interference, and/or earth potential rise. Generally, these external conditions may introduce a surge component to the Ethernet signal. The surge component may include a surge voltage and/or a surge current.

Excessive surge voltage and/or surge current may cause damage to the Ethernet interface devices (not shown) of the first Ethernet enabled computer 105 and the second Ethernet enabled computer 107. To protect the Ethernet interface devices from surge voltage and/or surge current, an ESP device (e.g., the internally mounted ESP devices 122) may be used for suppressing and/or filtering out the surge component of the Ethernet signal. The ESP device may output the filtered or surge suppressed Ethernet signals to one or more protected Ethernet cables, such as the first protected Ethernet cable 142 and the second protected Ethernet cable 144. Consequently, the filtered or surge suppressed Ethernet signals may be delivered to the first Ethernet enabled computer 105 and the second Ethernet enabled computer 107.

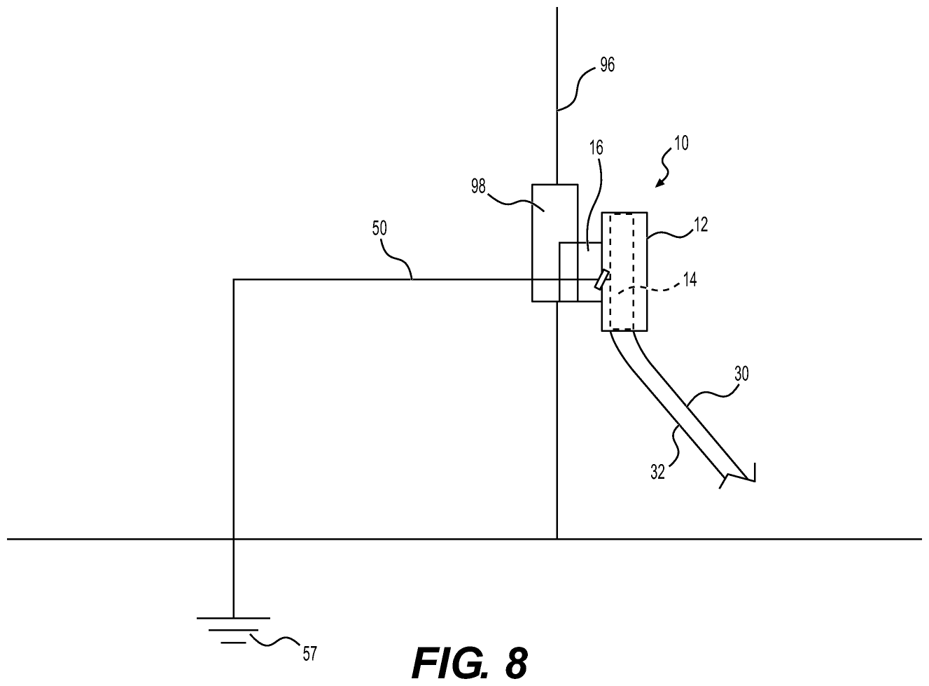

The ESP device may be mounted inside the building 101. More preferably, the ESP device may be mounted to a wall 104 of the building 101 and in some embodiments may use a dedicated mounting fixture 110. The mounting fixture 110 may include one or more panels for holding the ESP devices. The mounting fixture 110 may have a zigzag shape as shown in FIG. 1. Therefore, traditional surge protection units require a dedicated bracket to mount the unit at a particular remote location. These dedicated brackets may be challenging to use given the amount of space the dedicated brackets require. Accordingly, referring to FIG. 8, various embodiments of the present disclosure may include a surge protection device 10 that can be mechanically mounted to a wall 96 at a three-prong outlet 98 while also electrically coupling the surge protection device 10 to a grounding wire 50 of a three-prong outlet 98 in order to protect downstream Ethernet equipment in the event of electric surge.

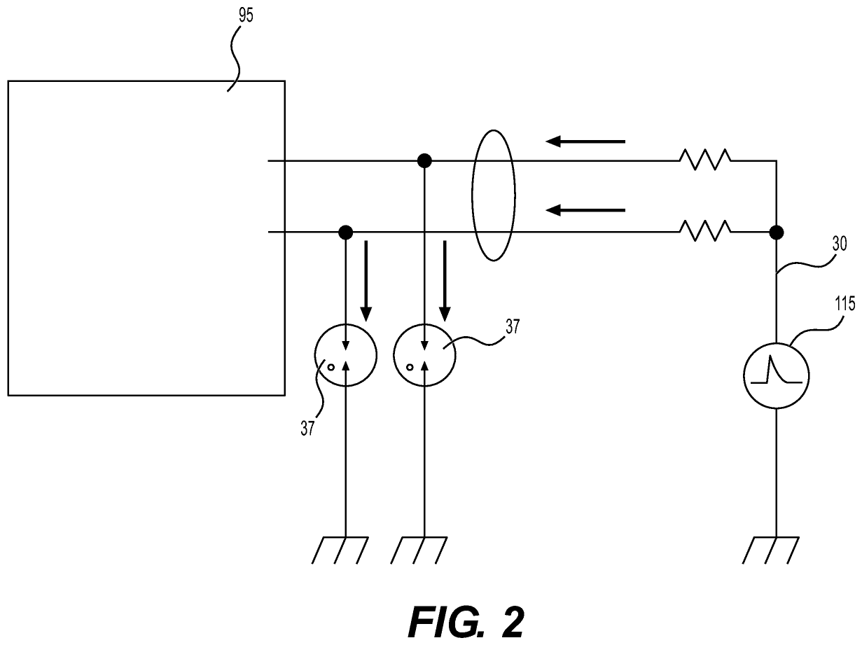

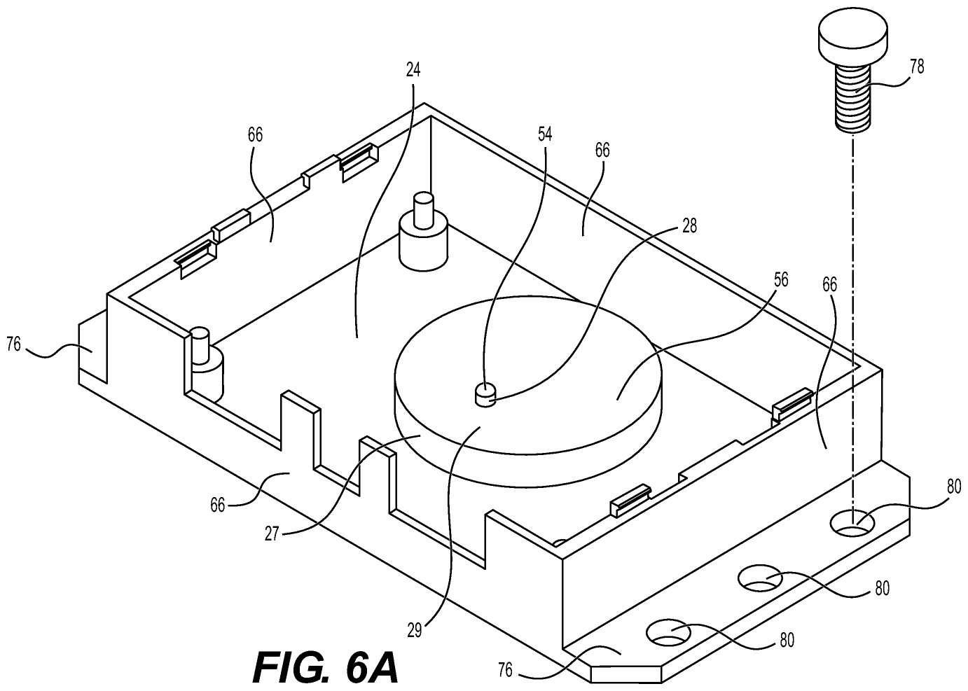

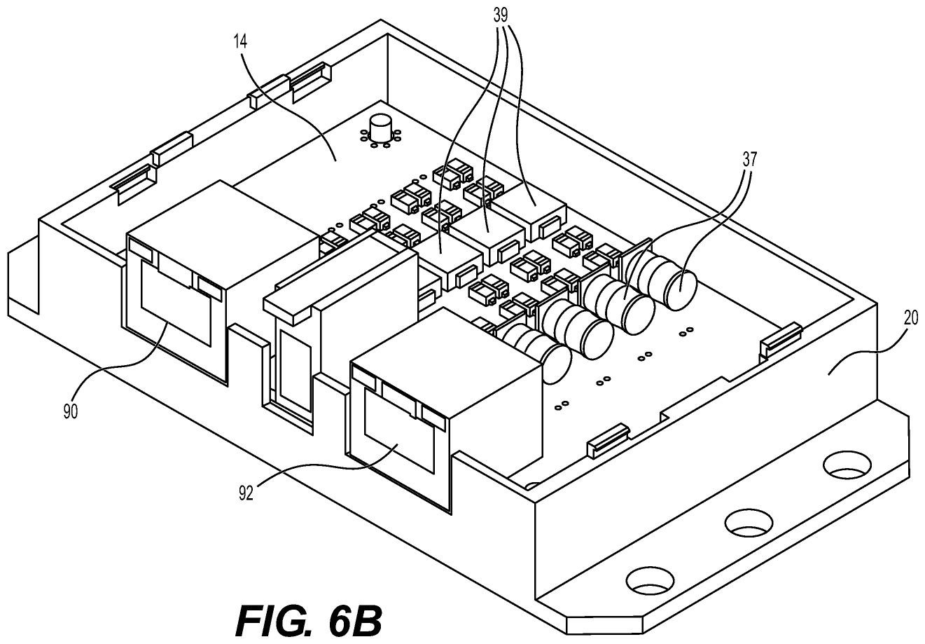

As shown in FIG. 2, a partial schematic circuit diagram is shown where a voltage surge is applied upstream of the Ethernet equipment 95 onto the multi-conductor cable 30. The cable 30 is electrically coupled to voltage limiting devices 37 on the printed circuit board (see element 14 in FIG. 6B). The voltage limiting devices 37 direct the excessive voltage to ground, such as via the grounding wire (see element 50 in FIG. 8).

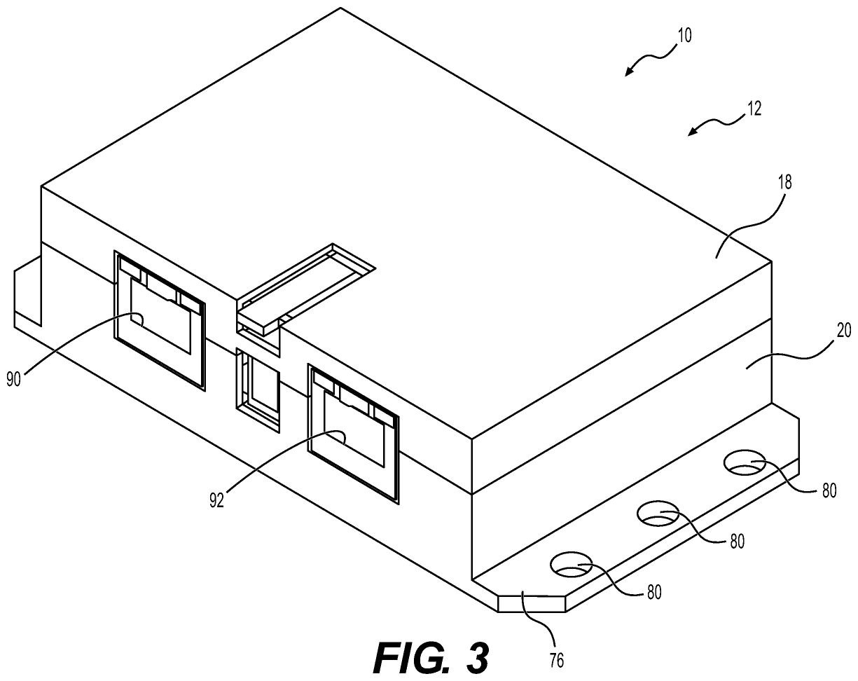

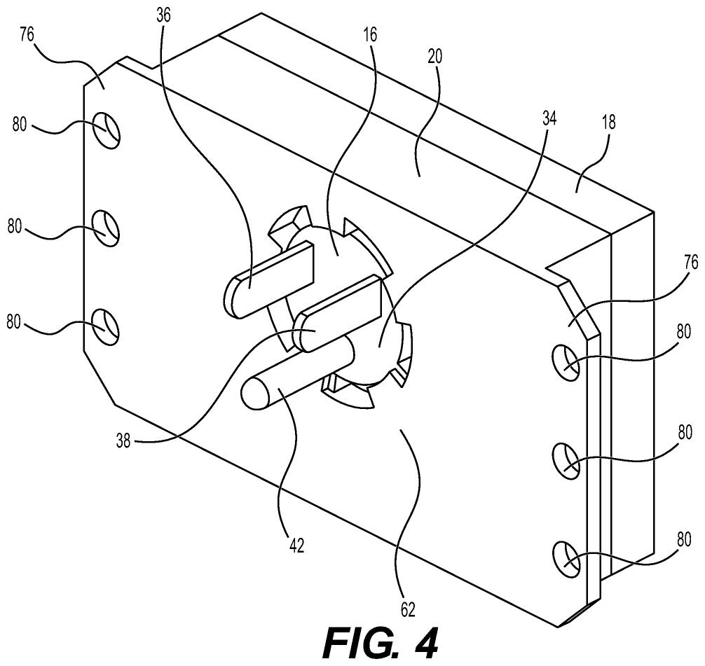

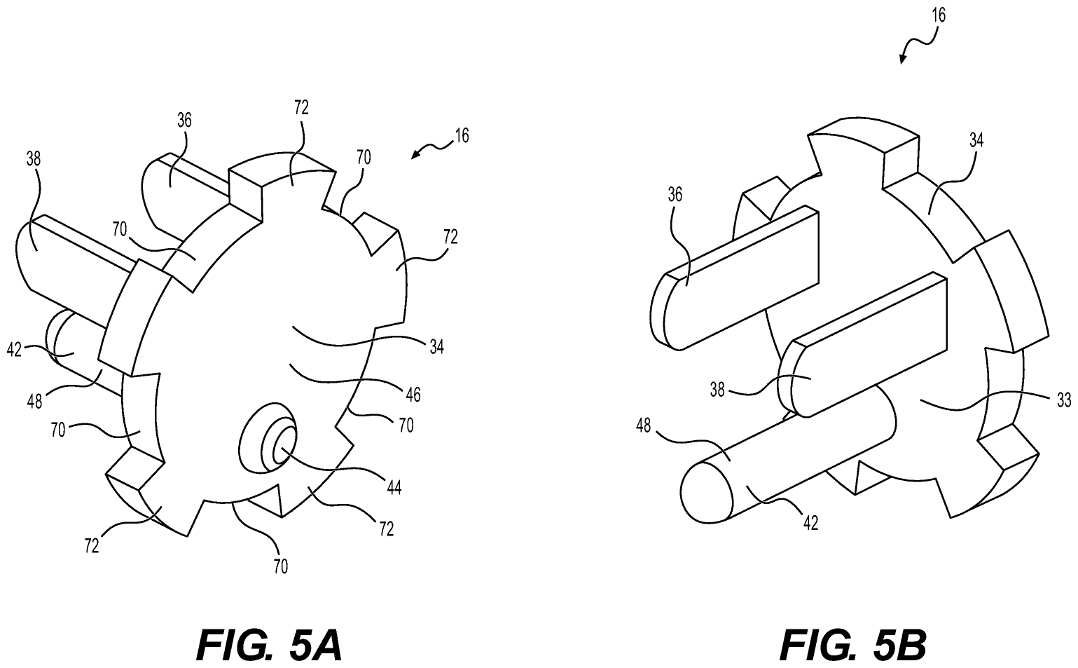

Referring now to FIG. 3, FIG. 4, FIGS. 5A-6B, and FIG. 8, an Ethernet surge protection device 10 is shown according to the present disclosure. The Ethernet surge protection device 10 may include a housing portion such as housing 12, a printed circuit board 14 (PCB), and a ground plug portion, such as ground plug 16. The housing 12 may include a first housing member or portion 18 and a second housing member or portion 20. The first housing member 18 may be a cover and the second housing member 20 may be a base. As shown in FIG. 3, an input port 90 for an input Ethernet cable 30 (shown in FIG. 8) and an output port 92 for an output ethernet cable 32 (shown in FIG. 8) may be included as part of the housing 12.

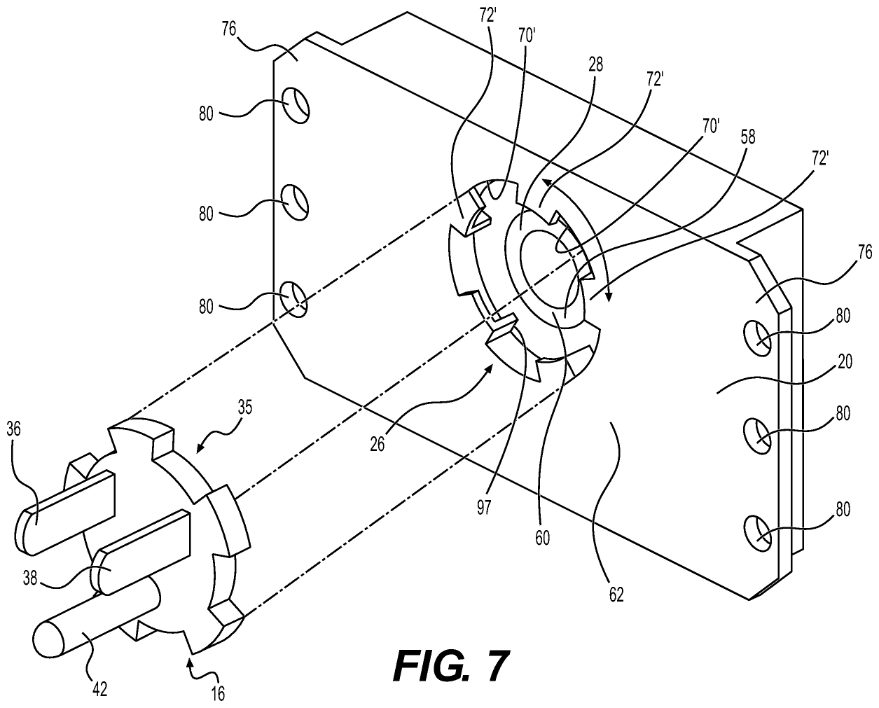

With reference to FIGS. 6-7, the second housing member 20 includes four side walls 66, a rear wall 24, a port 26 defined in the rear wall 24, and an electrical coupling member 28 disposed within the port 26. It is understood that the rear wall 24, the port 26, and the side walls 66 may be formed via an injection molding process wherein a portion of the electrical coupling member 28 is disposed in the port 26 of the second housing member 20. That is, a portion of the electrical coupling member 28 may be embedded in a portion of the second housing member 20 via the injection molding process. The first housing member 18 may also be formed via an injection molding process.

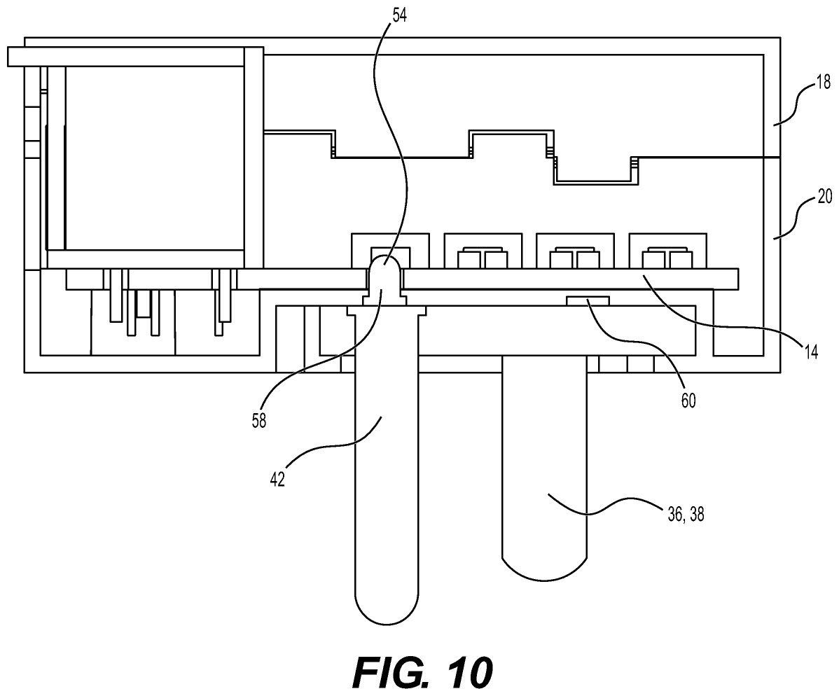

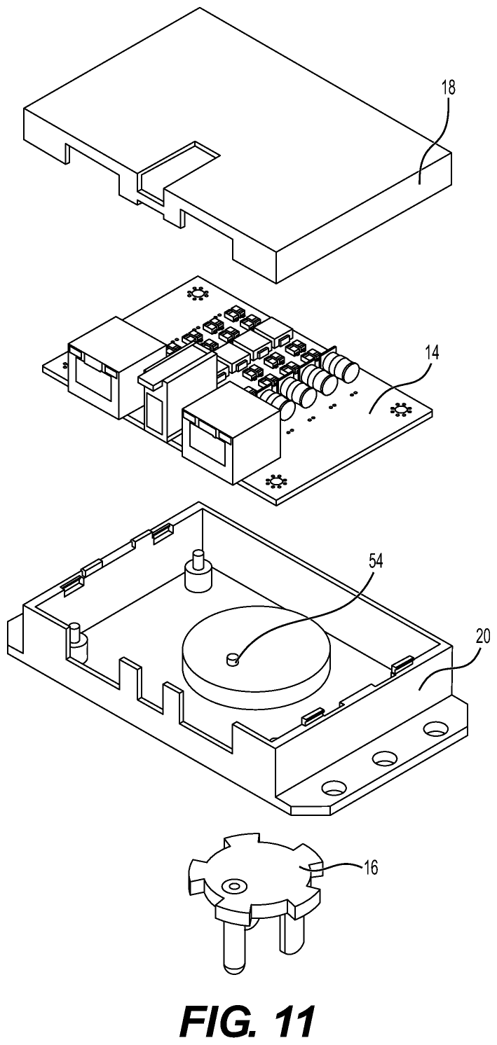

As shown in FIG. 6B and FIG. 10, the printed circuit board 14 may be disposed within the housing 12 and may be electrically coupled to an input Ethernet cable 30 and an output Ethernet cable 32. The printed circuit board (PCB) 14 may include a plurality of voltage limiting devices 37 and a plurality of current limiting devices 39. Accordingly, the printed circuit board 14 and the plurality of voltage limiting devices 37 and the plurality of current limiting devices 39 may constitute a filter. The PCB 14 may also include an input port bonding pad and an output port bonding pad. The input port bonding pad may provide an area for receiving, aligning, and bonding the Ethernet input port 90. The output port bonding pad may provide an area on the printed circuit board 14 for receiving, aligning, and bonding the Ethernet output port 92. As later described herein, the surge protection device 10 includes an electrical coupling member or portion 28 embedded in the second housing member 20 (see FIG. 6) wherein the electrical coupling member 28 and a ground plug portion 16 are configured to electrically couple the printed circuit board 14 with a ground, such as grounding wire 50 of a electrical wall outlet, such as three-prong outlet 98 (see FIG. 8).

As shown in FIGS. 5A-5B, the ground plug 16 includes a panel portion 34, a dummy portion that may include a first dummy prong 36 and a second dummy prong 38 extending from a second side of the panel 34, and a ground portion, such as ground prong 42. The panel 34, the first dummy prong 36 and the second dummy prong 38 in some embodiments may be formed from a nonconductive material and may be formed via an injection molding process. The ground prong 42 may be formed from a conductive material and includes a proximate end 44 extending beyond a first side 46 of the panel 34 and a distal end 48 extending beyond the second side of the panel 34. The proximate end 44 of the ground prong 42 is configured to be electrically coupled to the printed circuit board 14 and the distal end 48 of the ground prong 42 is configured to be electrically coupled to a grounding wire 50 in a three-prong outlet 98.

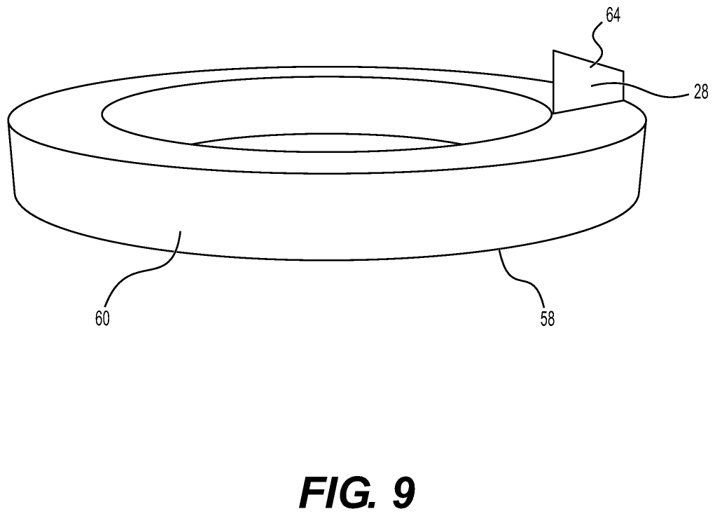

As shown in FIG. 6A, the electrical coupling member 28 of the second housing member 20 is configured to have a first end portion 54 extending beyond an interior side 56 of the second housing member 20 and a second end portion 58 (shown in FIG. 7). The second end 58 of the electrical coupling member 28 may be a ring 60 such that at least a portion of the ring 60 is configured to extend beyond the rear exterior side 62 of the second housing member 20 within the port 26. As shown in FIG. 9, the electrical coupling member 28 may be formed by a prong 64 that extends from a ring 60. As shown in FIG. 6A, the second housing member may include a raised platform 27 that may be injection molded as part of the interior side 56 so that the prong 64 is laterally supported and will not be susceptible to bending. The ring-like configuration of the second end 58 of the electrical coupling member 28 enables electrical contact with the ground plug 16 regardless of the rotational position of the ground plug 16—given that the ground plug 16 may be configured to rotate relative to the housing 12 to lock the ground plug 16 onto the housing 12. As indicated, the ring 60 (second end 28) of the electrical coupling member is disposed within the port 26. The port 26 is defined on a rear exterior side 62 of the second housing member 20 such that the port 26 is configured to receive the panel 34 end of the ground plug 16. As shown in FIGS. 4 and 8, the ground plug 16 is configured with a shape of the prongs 36, 38 and 42 to mechanically couple the housing 12 to the three-prong outlet 98 on a wall 66.

The ground plug 16 may be rotated relative to the housing 12 so that the ground plug 16 is structurally configured to be removable from the housing 12 and from the Ethernet surge protection device 10. While the figures illustrate a ground plug 16 configured to plug into a standard 120V three-prong wall outlet, embodiments disclosed herein may function with other wall outlets, such as a 220V wall outlet. A different ground plug may replace the ground plug 16 in the housing of the surge protection device, with the different ground plug having a configuration to fit into a corresponding different wall outlet. The different ground plug will have prongs with a placing, shape and size of the prongs configured to fit into the corresponding wall outlet.

For example, when using with a 220V wall outlet, the placing, size and shape of the prongs on the ground plug will correspond to the 220V outlet so that the ground plug can be plugged into the 220V outlet while connecting the ground prong to the ground of the 220V outlet. The different ground plug still has the tabs 70 and recesses 72 so that it may easily be inserted into the housing of the surge protection device. In this manner, the surge protection device is configured to function with various different types of wall outlets.

Noting that the proximate end 44 of the ground prong 42 is a protrusion that extends beyond the first side 46 of the panel 34 (see FIG. 5A) and noting that at least a portion of the ring 60 of the electrical coupling member 28 extends beyond the rear exterior side 62 within the port 26 (see FIG. 7), the proximate end 44 of the ground prong 42 and the ring 60 are structurally configured to be in electrical contact when the ground plug 16 is mounted in the port 26. Accordingly, given that the first end 54 of the electrical coupling member 28 is in electrical communication with the PCB, the ground prong 42 and the electrical coupling member 28 of the housing 12 are configured to electrically couple the printed circuit board 14 to the grounding wire 50 when the housing 12 is coupled to the three-prong outlet 52 such that an electrical surge is transmitted to the grounding wire 50 in the three-prong outlet 52.

As shown in FIG. 7, the ground plug 16 and the housing 12 are configured to rotate relative to each other in order to mount the ground plug 16 to the housing 12. As shown, the ground plug 16 and the second housing member 20 may each include matching recesses 70, 70′ and tabs 72, 72′ such that the panel 34 of ground plug 16 may be disposed within a channel 97 defined in the port 26 and then, upon rotating the ground plug 16 relative to the second housing member 20, the tabs 72, 72′ of ground prong 42 and the second housing member 20 are aligned with each other thereby securing the ground plug 16 to the second housing member 20 (and housing 12). Accordingly, the ground plug 16 is configured to mechanically couple the housing 12 to the wall 66 and the ground plug 16 is configured to electrically couple the printed circuit board 14 to a grounding wire 50 in a three-prong outlet 52 such that an electrical surge may be transmitted from the printed circuit board 14 to the grounding wire 50 thereby preventing damage to any Ethernet equipment 95.

It is also understood that the housing 12 may include flanges 76 that define apertures 80 wherein each aperture 80 is configured to receive a mechanical fastener 78 such that the housing 12 may be mechanically mounted to a surface (such as a wall 66) via mechanical fasteners 78 together with the ground plug 16. In the example shown in FIG. 4, the second housing member 20 includes a pair of flanges 76 wherein each flange 76 defines a plurality of apertures 80. Each aperture 80 in the plurality of apertures 80 may receive a mechanical fastener 78 that is configured to mount the housing 12 to a surface such as a wall 66.

While multiple exemplary, non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A surge protector structurally configured to protect Ethernet equipment from an electric surge, comprising:
a housing portion configured to have a first housing portion and a second housing portion;
a printed circuit board structurally configured to be disposed within the housing portion and configured to be electrically coupled with an input Ethernet cable and with an output Ethernet cable;
a ground plug portion structurally configured to include a panel portion, a dummy portion, and a ground portion;
wherein the second housing portion is structurally configured to include an electrical coupling portion;
wherein the ground portion is structurally configured to include a proximate end extending beyond a first side of the panel portion and a distal end extending beyond a second side of the panel portion;
wherein the ground portion is structurally configured to extend from the second side of the panel portion;
wherein the proximate end of the ground portion is structurally configured to be electrically coupled with the printed circuit board via the electrical coupling portion, and the distal end of the ground portion is structurally configured to be electrically coupled with a ground of an electrical wall outlet;
wherein the second housing portion is configured to define a port on a rear exterior side of the housing portion such that the port is structurally configured to receive the panel portion of the ground plug portion;
wherein the electrical coupling portion of the second housing portion includes a first end structurally configured to extend beyond an interior side of the second housing portion and a second end;
wherein the second end of the electrical coupling portion is a ring such that at least a portion of the ring is structurally configured to extend beyond the rear exterior side of the second housing portion;
wherein the ground plug portion is structurally configured to mechanically couple the housing portion to an electrical wall outlet; and
wherein the ground portion and the electrical coupling portion of the housing portion are structurally configured to electrically couple the printed circuit board to a ground of an electrical wall outlet via the ground plug portion when the housing portion is coupled to the electrical wall outlet such that an electrical surge on the input Ethernet cable is directed to the ground of the electrical wall outlet so as to protect equipment that is electrically connected with the output Ethernet cable from the electrical surge.

2. The surge protector of claim 1, wherein the printed circuit board is configured with a voltage limiting portion configured to direct any excess voltage received from the Ethernet input cable through the ground plug portion to the ground of the electrical wall outlet.

3. The surge protector of claim 1, wherein the printed circuit board is configured with a current limiting portion configured to direct any excess current received from the Ethernet input cable through the ground plug portion to the ground of the electrical wall outlet.

4. The surge protector of claim 1, wherein the ground plug portion is structurally configured to be removably coupled with the housing portion.

5. A surge protector system, comprising:
the surge protector of claim 4;
an additional ground plug portion that includes a ground portion and a dummy portion;
wherein the additional ground plug portion is structurally configured to be removably coupled with the housing portion; and
wherein a size, shape, or configuration of the ground portion and/or the dummy portion of the additional ground plug portion is different than a size, shape, or configuration of the ground portion and/or the dummy portion of the ground plug portion.

6. The surge protector of claim 1, wherein the dummy portion comprises two prongs, and the ground portion comprises an additional prong.

7. A surge protector structurally configured to protect Ethernet equipment from an electrical surge, comprising:
an Ethernet cable input portion structurally configured to receive an Ethernet input cable;
an Ethernet cable output portion structurally configured to receive an Ethernet output cable to connect to an Ethernet device;
a ground plug portion having a dummy portion and a ground portion;
a printed circuit board structurally configured to be electrically coupled to the ground portion, to the Ethernet cable input portion, and to the Ethernet cable output portion; and
wherein the ground portion is structurally configured to connect with an electrical wall outlet so as to direct an electrical surge on the input Ethernet cable to a ground of the electrical wall outlet via the printed circuit board so as to protect equipment that is electrically connected with the output Ethernet cable from the electrical surge.

8. The surge protector of claim 7, wherein the printed circuit board is configured with a voltage limiting portion configured to direct any excess voltage received from the Ethernet input cable through the ground plug portion to the ground of the electrical wall outlet.

9. The surge protector of claim 7, wherein the printed circuit board is configured with a current limiting portion configured to direct any excess current received from the Ethernet input cable through the ground plug portion to the ground of the electrical wall outlet.

10. The surge protector of claim 7, further comprising a housing portion configured to have a first housing member and a second housing member having an electrical coupling portion.

11. The surge protector of claim 10, wherein the ground portion and the electrical coupling portion of the housing portion are configured to electrically couple the printed circuit board to the ground of the electrical wall outlet when the housing portion is coupled to the electrical wall outlet through the ground plug portion.

12. The surge protector of claim 10, wherein the ground plug portion is structurally configured to be removably coupled with the housing portion.

13. A surge protector system, comprising:
the surge protector of claim 12;
an additional ground plug portion that includes a ground portion and a dummy portion;
wherein the additional ground plug portion is structurally configured to be removably coupled with the housing portion; and
wherein a size, shape, or configuration of the ground portion and/or the dummy portion of the additional ground plug portion is different than a size, shape, or configuration of the ground portion and/or the dummy portion of the ground plug portion.

14. The surge protector of claim 12, wherein the dummy portion comprises two prongs, and the ground portion comprises an additional prong.

15. A surge protector structurally configured to protect Ethernet equipment from an electrical surge, comprising:
an Ethernet cable input portion structurally configured to receive an Ethernet input cable;
an Ethernet cable output portion structurally configured to receive an Ethernet output cable to connect to an Ethernet device;
a ground plug portion having a dummy portion and a ground portion; and
wherein the ground portion is structurally configured to connect to an electrical wall outlet so as to direct an electrical surge on the input Ethernet cable to a ground of the electrical wall outlet so as to protect equipment that is electrically connected with the output Ethernet cable from the electrical surge.

16. The surge protector of claim 15, further comprising a printed circuit board configured to be electrically coupled to the ground plug portion, to the Ethernet cable input portion and to the Ethernet cable output portion

17. The surge protector of claim 15, wherein the printed circuit board is configured with a voltage limiting portion configured to direct any excess voltage received from the Ethernet input cable through the ground plug portion to the ground of the electrical wall outlet.

18. The surge protector of claim 15, wherein the printed circuit board is configured with a current limiting portion configured to direct any excess current received from the Ethernet input cable through the ground plug portion to the ground of the electrical wall outlet.

19. The surge protector of claim 15, further comprising a housing portion configured to have a first housing member and a second housing member having an electrical coupling portion.

20. The surge protector of claim 19, wherein the ground prong portion and the electrical coupling portion of the housing portion are configured to electrically couple the printed circuit board to the ground of the electrical wall outlet when the housing portion is coupled to the electrical wall outlet through the ground plug portion.

21. A surge protector system, comprising:
the surge protector of claim 19;
an additional ground plug portion that includes a ground portion and a dummy portion;
wherein the additional ground plug portion is structurally configured to be removably coupled with the housing portion; and
wherein a size, shape, or configuration of the ground portion and/or the dummy portion of the additional ground plug portion is different than a size, shape, or configuration of the ground portion and/or the dummy portion of the ground plug portion.

22. The surge protector of claim 21, wherein the ground plug portion is structurally configured to be removably coupled with the housing portion.
